(19) United States
(12) Patent Application Publication
(10) Pub. No.: US 2021/0285574 A1
(43) Pub. Date: Sep. 16, 2021

(54) ADJUSTABLE POLYMERIC PIPE FLASHING SYSTEM FOR IMPERMEABLE GEOTECHNICAL APPLICATIONS

(71) Applicant: Solmax International Inc., Varennes, Québec (CA)

(72) Inventor: Vincent Philippe Guillette, Vercheres (CA)

(21) Appl. No.: 17/260,080

(22) PCT Filed: Jul. 23, 2019
(86) PCT No.: PCT/CA2019/051013

§ 371 Date: Jan. 13, 2021

Related U.S. Application Data
(60) Provisional application No. 62/702,052, filed on Jul. 23, 2018.

(51) Int. Cl. F16L 5/10; C08F 10/02; B29C 33/42

(52) U.S. Cl. CPC F16L 5/10; B29C 33/42; C08F 10/02

(57) ABSTRACT

The present invention relates to an adjustable polymeric pipe flashing system (also known as a “pipe boot” or “geomembrane boot”) that allows for angle adjustability without the need for assembly aids. The polymeric pipe flashing system is made of a single piece using methods known in the art such as, without limitation, vacuum molding. The pipe flashing system comprises a sleeve with one or more disk-like elements having different diameters to accommodate a variety pipes, a flexible skirt and free-field geomembrane base. The sleeve may be adjusted to accommodate the size of the pipe that is to be rendered leak-resistant. The flexible skirt and free-field geomembrane base are pliable and may be adjusted over an angled pipe without breaking. In one embodiment, the pipe flashing system has sufficient flexibility to be used with pipes having a pitch of approximately 3/1.

### CROSS-REFERENCE TO RELATED APPLICATIONS

The present patent application claims the priority of U.S. Provisional Patent Application No. 62/702,052 titled “Polymeric Adjustable Pipe Flashing System for Impermeable Geotechnical Applications” filed on Jul. 23, 2018.

### FIELD OF THE INVENTION

The present invention relates to the field of pipe flashing systems (also called “geomembrane boots” or “pipe boots”) used in impermeable geotechnical applications. Pipe flashing systems serve to create a leak-resistant connection around pipe penetrations (called “boots”) that are attached to a structure, such as a geomembrane.

### BACKGROUND OF THE INVENTION

Two types of leak-resistant geomembrane boots are recognized in the art: (1) clamped and gasketed (or otherwise sealed) connections to pipes and (2) prefabricated boots.

R. Thiel and G. DeJarnett provide a comprehensive review of the state of the art in their paper titled “Guidance on the Design and Construction of Leak-Resistant Geomembrane Boots and Attachments to Structures”. Some of the teachings of this paper, which is published on the Internet¹, are summarized below. ¹ Thiel, R. and DeJarnett, G. Guidance on the Design and Construction of Leak-Resistant Geomembrane Boots and Attachments to Structures, GRI Session of the IFAI-sponsored conference, Geo 2009, Salt Lake City, February 2009.

Except in the case of polyethylene geomembranes connected to High Density Polyethylene (HDPE) pipes, which can have a welded connection, all other boot sleeves will be clamped around the pipe and have either a gasket or other sealant between the pipe wall and the boot sleeve. Common problems associated with these installations include the following:
The gasket material is overlapped and creates a void that may leak at the lap.
The welds are often in difficult geometries and not easily accessible.
The geomembrane material is overlapped to create a sleeve seam, creating a void at the end of the lap that may leak. Leakage may also occur between the two layers of the laps.
The clamping force from the outer bands or clamps often results in wrinkles in the boot sleeve that may allow leakage.
The clamping force on the gaskets is usually not controlled or measured, but is subjectively applied. Clamping with too low or too high a force may result in a gasket that does not perform properly. There is no known perfect solution for this issue with gaskets.
Gaskets deteriorate with time and exposure. In addition, it is important to select gaskets, mastics or caulks that are chemically compatible for their intended use.
Gaskets are meant to elastically deform and retain resiliency. When they are compressed past their elastic limit, they may lose their resiliency.
Solid gaskets require a smooth, hard and even substrate to create a good seal.

Prefabricated boots have the sleeve and the skirt premanufactured in a single piece, thus eliminating the sleeve-to-skirt weld which is often a weak spot. Prefabricated boots made from polyethylene (PE) are often vacuum-formed from base stock material that is substantially thicker than the project-specified geomembrane with the result that when it is stretched into shape, the thinnest spots will have the minimum required thickness. The resulting sleeve will be seamless and will not have a lap joint, which will improve its leak resistance and aid in achieving a uniform clamping pressure. Prefabricated boots made from other materials such as ethylene propylene diene monomer (EPDM), polyvinyl chloride (PVC) or polypropylene (PP) can be factory molded or preformed, and sometimes have a stepped-cone or tapered shape where the cone can be cut off at the desired diameter of the pipe. An example of a prefabricated boot of this type is described in U.S. Pat. No. 7,714,709 B1, wherein the pipe boot is made of a semi-rigid elastomeric material such as rubber, vinyl, thermoplastic polyolefin (TPO) or PVC. This pipe boot is manufactured at standardized inner diameters to fit around the outer diameter of commonly used pipe sizes that are installed on roofs.

As with clamped and gasketed connections to pipes, prefabricated boots also have certain disadvantages. The following reasons are frequently invoked by experts in the art to explain why prefabricated pipe boots are not used:
The geometry of the pipe boot must be defined ahead of time. The stiffer the geomembrane, the more critical this becomes.
The two most important geometric dimensions that must be accurately defined to order a prefabricated boot are: (1) the outside diameter of the pipe and (2) the angle of the pipe to the subgrade. Having field conditions vary from assumed design conditions is often “the norm” to be expected on projects, and even small variations can render a prefabricated boot useless.
If the diameter or angle of the pipe boot is off, then the integrity of the boot may become compromised due to a poor seal or risking a bridged void at the base of the boot.
“It never fits” is a common comment regarding prefabricated boots. There is often little incentive for installers to order prefabricated boots because they know the chances of getting the wrong order are high, or waiting to order the boot until the exact field conditions are known will delay a project.
Finally, there are many instances where the end of the pipe is not accessible and the boot cannot be slipped over the end of the pipe, necessitating a sleeve.

There thus remains a need for a prefabricated polymeric adjustable pipe flashing system or pipe boot for use in impermeable geotechnical applications that can overcome the disadvantages associated with those that are currently available.

### Object of the Invention

An objective of the present invention is to provide an adjustable pipe flashing system or pipe boot that allows for angle adjustability without the need for assembly aids.

### SUMMARY OF THE INVENTION

In its simplest form, the pipe flashing system or pipe boot comprises a sleeve that is connected seamlessly to a flexible skirt which leads to a free-field geomembrane base.

In one embodiment of the present invention, the sleeve of the pipe boot is comprised of a series of disk-like elements that allow the sleeve to be tailored to accommodate the size of the pipe that requires sealing.

The flexible skirt allows the pipe to be adjusted to an angled pipe by compensating for the added tensile and compression stresses. This may be done manually without the need for equipment.

The field-free membrane base eliminates the need to perform welding procedures in the crevasse of a traditional angled pipe boot by shifting the weld area outwards to a more accessible flat portion of the geomembrane much like a patch, as would be known by a person of skill in the art.

The flexible skirt 200 and the field-free membrane base may be produced in any shape that will serve the purposes of the pipe boot, such as a circle, oblong or oval. The chosen configuration allows the pipe boot to be securely positioned on different piping configurations, ensuring a proper seal.

The pipe boot is manufactured from polymers as a single piece using methods that are known in the art, such as, without limitation, vacuum molding.

Conveniently, the pipe flashing system is stackable, allowing for multiple unit shipping.

### BRIEF DESCRIPTION OF THE DRAWINGS

The features and advantages of the invention will become more readily apparent from the following description, reference being made to the accompanying drawings in which:

FIG. 1 is a perspective view of an embodiment of the pipe boot in accordance with the present invention which has a generally oblong shape;

FIG. 2 is a perspective view of a second embodiment of the pipe boot in accordance with the present invention highlighting its flexibility or adaptability;

FIG. 3 is a perspective view of an alternative embodiment of a pipe boot of the present invention wherein the pipe boot is adjusted onto a pipe using an extrusion weld;

FIG. 4 is a perspective view of an embodiment of a mold for making a pipe boot in accordance with the present invention having a generally circular shape and three disk-like elements;

FIG. 5 is an exploded view of the mold shown in FIG. 4; and

FIG. 6 is a cross-sectional view of a mold for vacuum forming of a pipe boot in accordance with the present invention showing multiple disk-like sleeve element options.

### DETAILED DESCRIPTION OF A PREFERRED EMBODIMENT

For purposes of the present application, “pipe flashing system”, “pipe boot” and “geomembrane boot” designate the same thing and are used interchangeably.

The terms “membrane” or “polymeric membrane” also designate the same thing and are also used interchangeably. They include, without limitation, a liner, sheet, layer or any other material that corresponds generally to a membrane, as would be appreciated by one of skill in the art.

The term “polymer” means a synthetic organic material such as a plastic or resin and includes, without limitation, one or more compounds chosen from the following: polypropylene (PP), polyethylene (PE), polyvinyl chloride (PVC), polyethylene of raised temperature (PE-RT), acrylonitrile butadiene styrene (ABS), Linear Low-Density PE (LLDPE), Low Density PE (LDPE), Medium Density PE (MDPE) and High Density PE (HDPE).

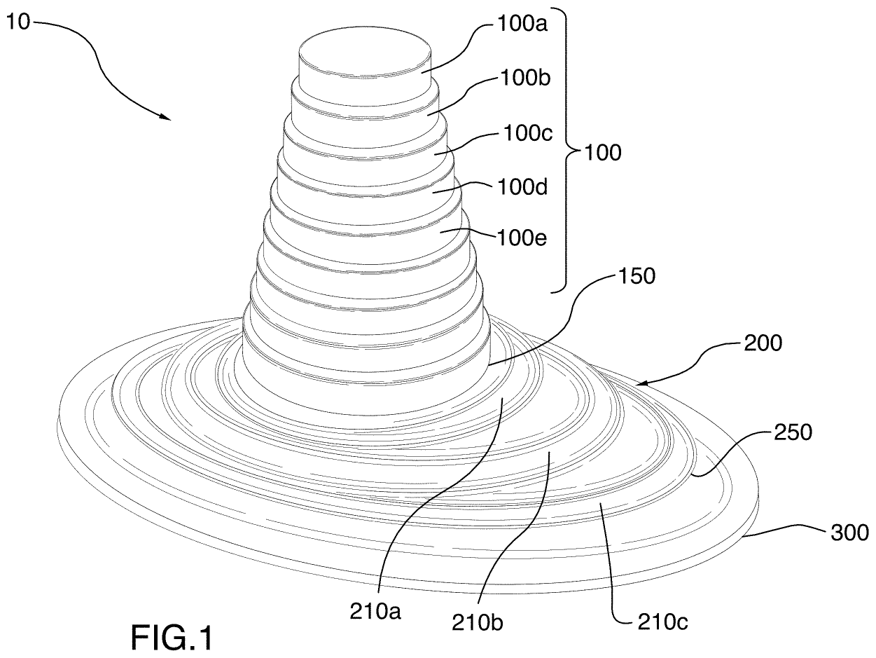

Referring to FIG. 1, a first embodiment of a pipe boot 10 is shown. The pipe boot 10 generally comprises three sections: (1) a sleeve 100 having the shape of a reverse taper and comprising one or more disk-like elements 100a, 100b, 100c, 100d, etc., which are concentric and have successively larger diameters from top to bottom; (2) a flexible skirt 200 having skirt sections 210a, 210b and 210c, and (3) a free-field geomembrane base 300. The three sections of the pipe 10 are joined seamlessly in a single piece made of the same polymeric material; as may be seen in FIG. 1, the sleeve 100 is fluidly linked to the flexible skirt 200 via a sleeve to flexible skirt connection 150, and the flexible skirt 200 is fluidly linked to the free-field geomembrane base via a flexible skirt to free-field geomembrane base connection 250. In this first representative embodiment, the flexible skirt 200 and free-field geomembrane base 300 have a generally oblong shape.

Each disk-like element 100a, 100b, 100c, 100d, etc., of the sleeve 100 is shaped to adapt to the contours of a variety of pipe sizes. During a leak containment operation, the sleeve 100 is cut at the level of the disk-like element chosen from 100a, 100b, 100c, 100d, etc., that has a diameter that is slightly larger than the pipe 1 (not shown) so that the pipe 1 may be pulled through the sleeve 100 and be surrounded by it.

One of skill in the art will appreciate that different sleeve shapes are possible. For example, in one embodiment of the invention, the sleeve 100 resembles a straight pipe (not shown) and has a diameter that is specifically tailored to accommodate the diameter of the pipe that it is meant to enclose.

In use, the skirt sections 210a, 210b and 210c of the flexible skirt 200 shown in FIG. 1 behave like pleats; that is, they may be pulled apart from each other or brought together (or expanded and contracted) without the use of any equipment. The skirt 200 of the pipe boot 10 is capable of axial, lateral or angular movement, and this enables the pipe boot 10 to have the necessary flexibility to be positioned over a broad range of angled pipes. Thus, the pipe boot 10 is not only suitable to be placed over vertical (approximately 90°)pipes, but also on pipes leaning towards a horizontal position (up to approximately 12°).

It has been found that the degree of flexibility in the skirt 200 of the pipe boot 10 may be tailored for specific applications through the choice of polymer (or polymer blends) used to make the pipe boot 10 and the number of skirt sections 210a, 210b, 210c, etc., included in the skirt 200.

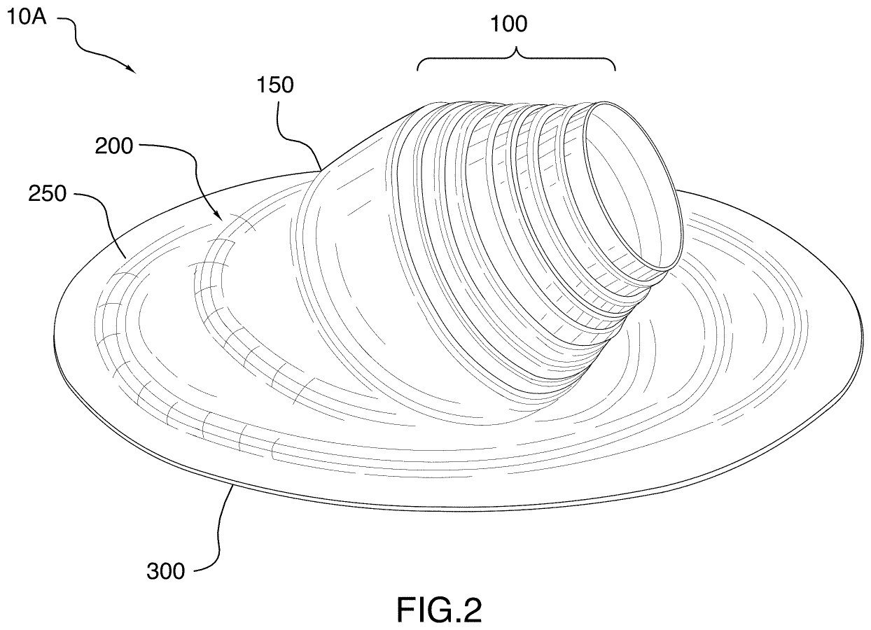

FIG. 2 illustrates a second embodiment 10A of the pipe boot 10 shown in FIG. 1, wherein the sleeve 100 is bent to fit over a slanted pipe. The inventors have been able to achieve a sleeve having a pitch of approximately 3/1. One skilled in the art will understand that the free-field geomembrane base 300 may assume other shapes that are suitable for particular pipe flashing purposes.

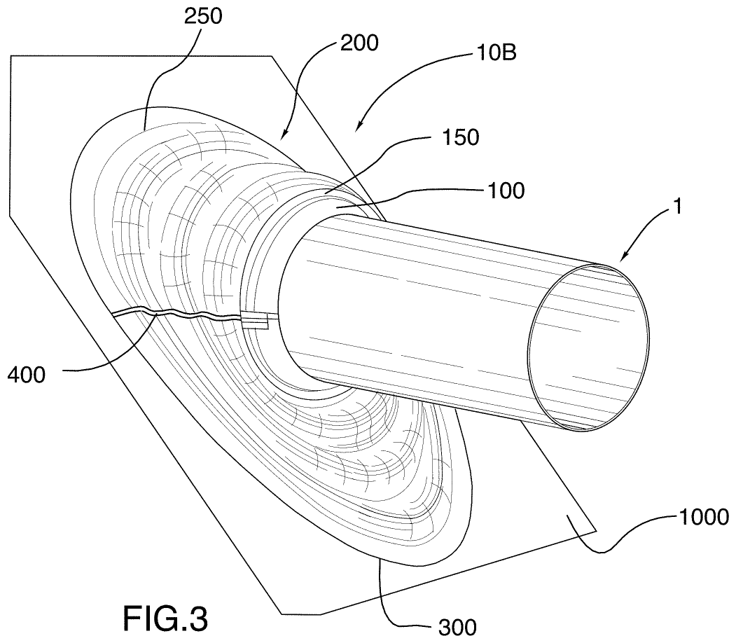

FIG. 3 shows yet another embodiment 10B of the pipe boot 10 shown in FIG. 1 wherein an extrusion weld 400 has been introduced in the pipe boot. While the invention is intended to be used without extrusion, in some cases, it is necessary to cut the pipe boot 10 in order to place it over a pipe, as would be appreciated by one of skill in the art.

FIG. 3 shows how the flexible skirt 200 and the free-field geomembrane base 300 act together to create a seal by fully surrounding the pipe 1 which passes through a geomembrane 1000.

As shown in FIG. 3, a pipe boot 10 is shown in use on an angled pipe. In this representative example, an asymmetrical distribution of polymer in the flexible skirt 200 was used to compensate for compressive forces; however, in the case of a pipe that is more or less vertical, a symmetrical distribution of polymer in the flexible skirt 200 may be preferred.

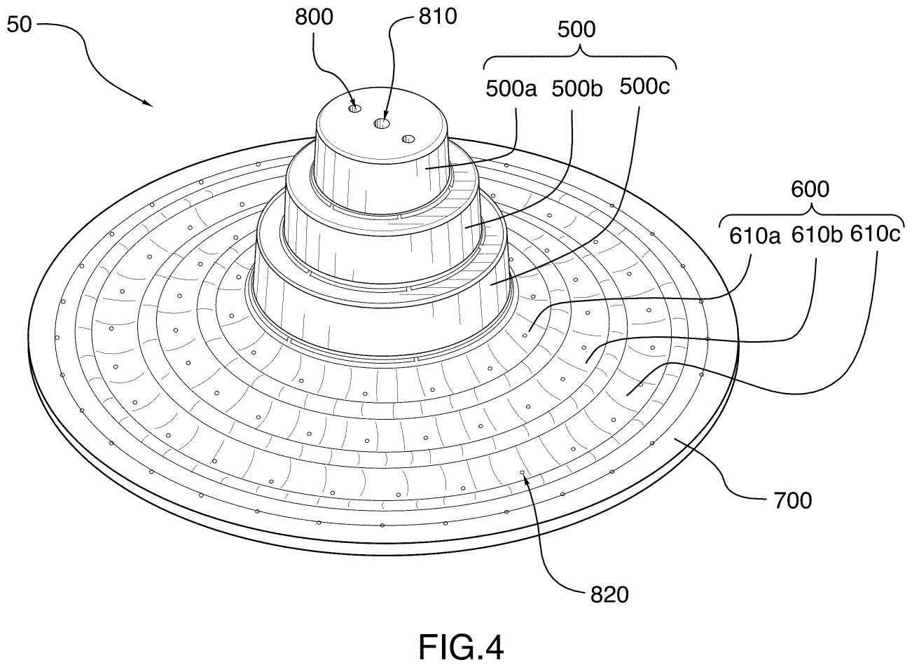

FIG. 4 shows a representative mold 50 for making a circular pipe boot. The mold 50 includes a sleeve-producing section 500 that comprises one or more disk-like producing portions 510a, 510b and 510c. One of skill in the art will appreciate that the sleeve-producing section 500 may include as many disk-like producing portions 510a, 510b, 510c, etc., as desired. The mold 50 further comprises a flexible skirt-producing section 600 and a free-field geomembrane base-producing section 700. The flexible skirt-producing section 600 comprises one or more skirt-producing elements 610a, 610b, 610c, etc., that together introduce flexibility in the skirt 200 of the pipe boot 10. The mold 50 further comprises apertures 800, 810 and 820 to enable the polymeric membrane used to make the pipe boot 10 to be vacuum formed into the desired shape.

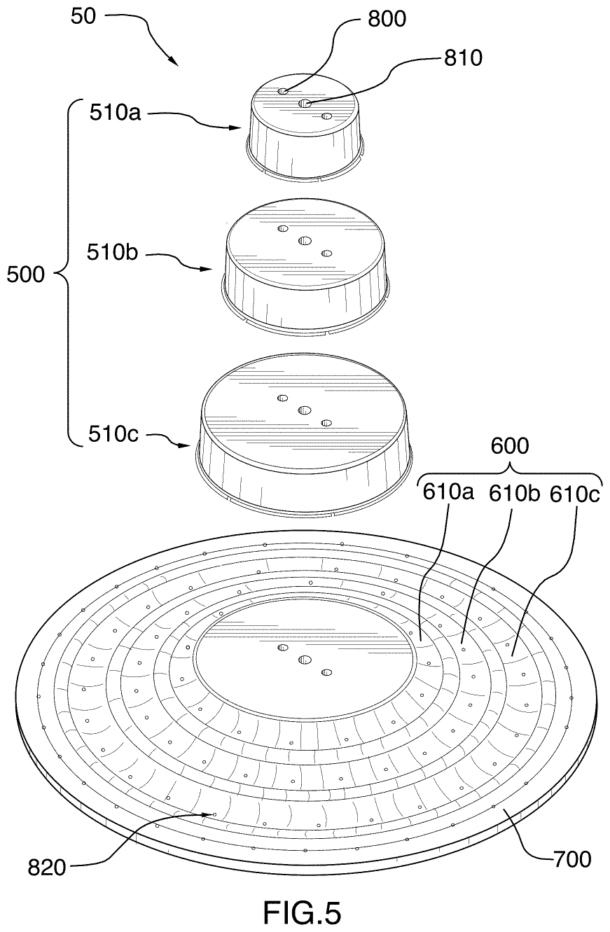

FIG. 5 is an exploded view showing the features of the representative mold 50 of FIG. 4 used to manufacture the pipe flashing system 10 of the present invention. The free-field geometric base 300 is adapted for easy installation since no extrusion is needed in cornered areas. This generally flat bottom may be outwardly extended to any desired length and be welded to a larger geomembrane sheet with ease. In addition, the system may be attached to the pipe by means of sealing tape and a metal collar.

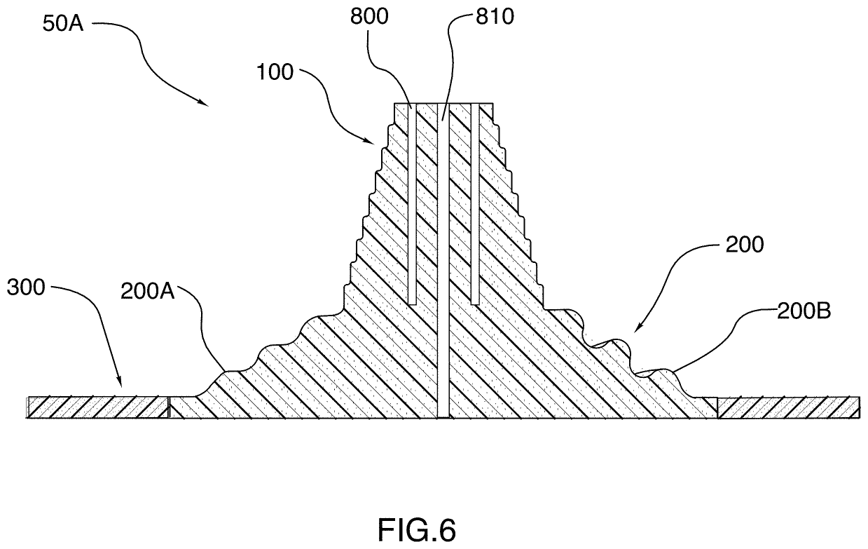

FIG. 6 is a cross-sectional view an alternative embodiment of a pipe boot mold 50A in which the flexible skirt 200 has been designed to be asymmetrical. The asymmetry is shown as 200A and 200B. From FIG. 6, it is possible to see the disk-like element options (corresponding to the disk-like producing portions 510a, 510b, 510c, etc., as shown in FIGS. 4 and 5) that make up the sleeve 100 of one representative embodiment of the pipe boot 10.

The stackable nature of the pipe boot 10 is suitable for use in multilayer geotechnical applications. In multilayer geotechnical containment systems, a pipe boot 10 can be welded onto a secondary containment layer and then another pipe boot 10 can be welded onto a primary containment layer so that they are stacked. Understandably, more than two pipe boots 10 may be stacked when there are multiple containment layers.

The present invention will find use in or with the following non-exclusive applications: mining, petrochemical, coal ash, coal seam gas, shale gas, biogas, aquaculture, agriculture, waste management, water, landscaping floating cover applications, geomembrane panels, bioreactor landfills, hot liquid storage, coal seam gas brine ponds, and geothermal waste water ponds.

The features of the present invention which are believed to be novel are set forth with particularity in the appended claims.

1) A polymeric, single-piece pipe flashing system for environmental containment that allows for angle adjustability without the need for assembly aids, said pipe flashing system comprising:
a sleeve;
a flexible skirt comprising 2 or more skirt sections; and
a free-field geomembrane base.

2) A polymeric, single-piece pipe flashing system for environmental containment as defined in claim 1, wherein the flexible skirt is capable of axial, lateral or angular movement.

3) A polymeric, single-piece pipe flashing system for environmental containment as defined in claim 2, wherein the pipe flashing system has flexibility to be positioned over pipes that range from the nearly vertical to the nearly horizontal.

4) A polymeric, single-piece pipe flashing system for environmental containment as defined in claim 3, wherein the nearly vertical is approximately 90° and the nearly horizontal is approximately 12°.

5) A polymeric, single-piece pipe flashing system for environmental containment as defined in claim 1, wherein the sleeve has the shape of a reverse taper and comprises one or more disk-like elements wherein each disk-like element has a diameter that is larger than the disk-like element above it.

6) A polymeric, single-piece pipe flashing system for environmental containment as defined in claim 1, wherein the sleeve has the shape of a pipe.

7) A polymeric, single-piece pipe flashing system for environmental containment as defined in claim 1, wherein the polymer is chosen from polypropylene (PP), polyethylene (PE), polyvinyl chloride (PVC), polyethylene of raised temperature (PE-RT), acrylonitrile butadiene styrene (ABS), or a mixture of any of these polymers.

8) A polymeric, single-piece pipe flashing system for environmental containment as defined in claim 7, wherein the polyethylene (PE) is chosen from Linear Low-Density PE (LLDPE), Low Density PE (LDPE), Medium Density PE (MDPE), High Density PE (HDPE), or a mixture of any of these polymers.

9) A mold for making a polymeric, single-piece pipe flashing system for environmental containment comprising:
a sleeve-producing section;
a flexible skirt-producing section comprising two or more skirt-producing elements; and
a free-field geomembrane base-producing section.

10) A mold for making a polymeric, single-piece pipe flashing system for environmental containment as defined in claim 9, wherein the sleeve-producing section has the shape of a reverse taper and comprises one or more disk-like producing portions.

11) A mold for making a polymeric, single-piece pipe flashing system for environmental containment as defined in claim 9, wherein the sleeve-producing section has the shape of a pipe.

12) A mold for making a polymeric, single-piece pipe flashing system for environmental containment as defined in claim 9, wherein the polymer for making the polymeric, single-piece pipe flashing system is chosen from polypropylene (PP), polyethylene (PE), polyvinyl chloride (PVC), polyethylene of raised temperature (PE-RT), acrylonitrile butadiene styrene (ABS), or a mixture of any of these polymers.

13) A mold for making a polymeric, single-piece pipe flashing system for environmental containment as defined in claim 12, wherein the polyethylene (PE) is chosen from Linear Low-Density PE (LLDPE), Low Density PE (LDPE), Medium Density PE (MDPE), High Density PE (HDPE), or a mixture of any of these polymers.

14) Use of a polymeric, single-piece pipe flashing system for environmental containment as defined in claim 1 in or with the following applications: mining, petrochemical, coal ash, coal seam gas, shale gas, biogas, aquaculture, agriculture, waste management, water, landscaping floating cover applications, geomembrane panels, bioreactor landfills, hot liquid storage, coal seam gas brine ponds, and geothermal waste water ponds.
